(19) United States
(12) Patent Application Publication
(10) Pub. No.: US 2008/0129081 A1
(43) Pub. Date: Jun. 5, 2008

(54) Vehicle door operating mechanism

(75) Inventor: Ben Ohly, Farmington, MI (US)

Correspondence Address: GLOBAL IP COUNSELORS, LLP, 1233 20TH STREET, NW, SUITE 700, WASHINGTON, DC, 20036-2680, US

(73) Assignee: Nissan Technical Center North America, Inc., Farmington Hills, MI (US)

(21) Appl. No.: 11/513,347

(22) Filed: Aug. 31, 2006

(51) Int. Cl. B60J 5/00

(52) U.S. Cl. 296/146.11

(57) ABSTRACT

A vehicle door operating mechanism includes a reversible electric motor, a rack member and a door rod. The reversible electric motor has an output gear. The rack member has teeth engaged with the output gear that movably arranged relative to the motor so that the rack member moves in response to rotation of the output gear of the motor. The door rod has a first rod end portion, a second rod end portion and a connector. The first rod end portion is operatively coupled to the rack member. The second rod end portion is configured and arranged to be operatively connected to a vehicle door. The connector couples the first and second rod end portions together to provide a limited amount of relative axial movement within the door rod between the first and second rod end portions.

### BACKGROUND OF THE INVENTION

1. Field of the Invention

The present invention generally relates to a vehicle door operating mechanism. More specifically, the present invention relates to a vehicle door operating mechanism that includes a noise reducing feature.

2. Background Information

Vehicles are complex machines with many moving parts that can rattle. While a rattle by itself is not necessarily a sign of a problem within a vehicle, rattles can be disquieting to drivers and passengers. It is therefore advantageous design elements of vehicles with rattle or vibration absorbing features.

In recent years, doors in many vehicles have been provided with door operating mechanisms where the door or doors are opened and closed using the power of a motor pulling or pushing the door between opened and closed positions. If a long rod is used between a portion of the door and the motor, vibrations of the door can be transmitted through the rod to the motor causing a rattle between gear teeth of the motor and other portions of the door operating mechanism.

In view of the above, it will be apparent to those skilled in the art from this disclosure that there exists a need for an improved door operating mechanism that reduces or eliminates rattling noises. This invention addresses this need in the art as well as other needs, which will become apparent to those skilled in the art from this disclosure.

### SUMMARY OF THE INVENTION

In accordance with one aspect of the present invention, a vehicle door operating mechanism includes a reversible electric motor having an output gear, a rack member and a door rod. The rack member has teeth engaged with the output gear. The rack member is also movably arranged relative to the motor so that the rack member moves in response to rotation of the output gear of the motor. The door rod has a first rod end portion, a second rod end portion and a connector. The first rod end portion is operatively coupled to the rack member. The second rod end portion is configured and arranged to be operatively connected to a vehicle door. The connector couples the first and second rod end portions together to provide a limited amount of relative axial movement within the door rod between the first and second rod end portions.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a perspective view of a vehicle that includes a motorized door operating mechanism that opens and closes a rear door in accordance with one embodiment of the present invention;

FIG. 2 is a side cross-sectional elevation of a rear portion of the vehicle depicted in FIG. 1 showing the rear door and the motorized door operating mechanism in accordance with one embodiment of the present invention;

FIG. 3 is a perspective view of the motorized door operating mechanism removed from the vehicle showing a motor, a guide member with an elongated slot and a door rod in accordance with one embodiment of the present invention;

FIG. 4 is a cross-sectional view of a portion of the motorized door operating mechanism taken along the line 4-4 in FIG. 3 showing the guide member and a first rod end portion of the door rod in accordance with one embodiment of the present invention;

FIG. 5 is a top plan view of a portion of the door rod showing a connector assembly in accordance with one embodiment of the present invention;

FIG. 6 is a cross sectional view of a portion of the connector assembly taken along the line 6-6 is FIG. 5 in accordance with one embodiment of the present invention;

FIG. 7 is an exploded perspective view of the door rod showing a portion of the first rod end portion, a second rod end portion and the anti-rattle assembly 18 in accordance with one embodiment of the present invention;

FIG. 8 is a cross-sectional view of the portion of the door rod and the connector assembly taken along the line 8-8 in FIG. 5 showing the door rod in tension in accordance with one embodiment of the present invention; and

FIG. 9 is another cross-sectional view of the portion of the door rod and the connector assembly similar to FIG. 8 showing the door rod in compression in accordance with one embodiment of the present invention.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

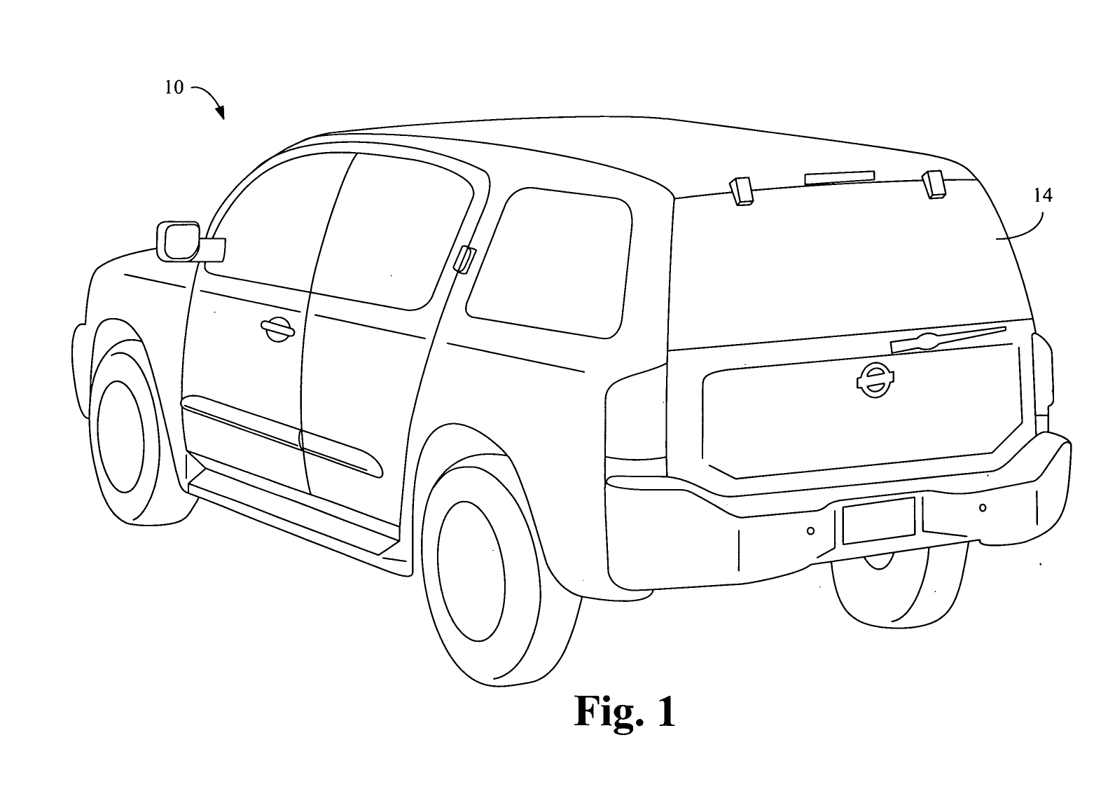

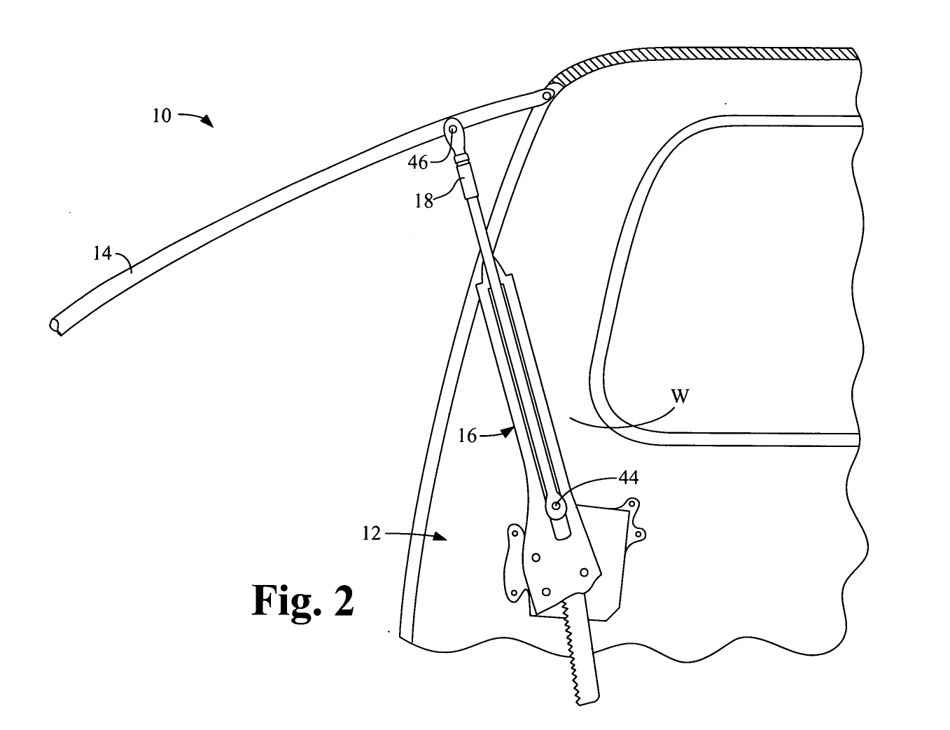

Referring initially to FIGS. 1 and 2, a vehicle 10 is illustrated in accordance with a first embodiment of the present invention. As shown in FIG. 2, the vehicle 10 includes a cargo area 12 that is accessed via a rear door 14 that includes a motorized door operating mechanism 16. The motorized door operating mechanism 16 is mounted to an interior wall W within the cargo area 12 of the vehicle 10 and connected to the rear door 14. The motorized door operating mechanism 16 includes an anti-rattle assembly 18, as described in greater detail below.

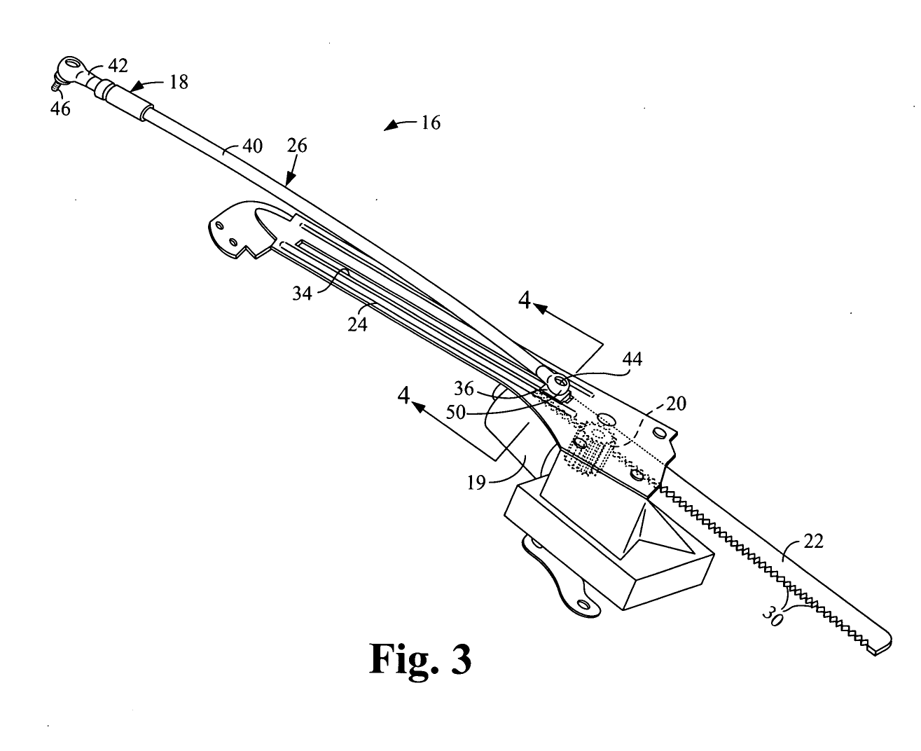

As best shown in FIG. 3, the motorized door operating mechanism 16 includes a reversible electric motor 19 that opens and closes the rear door 14 automatically or via a remote switch (not shown) manipulated by the vehicle operator. The motorized door operating mechanism 16 also includes an output gear 20 connected to the motor 19, a rack member 22, a guide member 24 and a door rod 26 with the anti-rattle assembly 18.

The rack member 22 has a plurality of gear teeth 30 engaged with the output gear 20 and movably arranged relative to the motor 19 so that the rack member 22 moves in response to rotation of the output gear 20 of the motor 19.

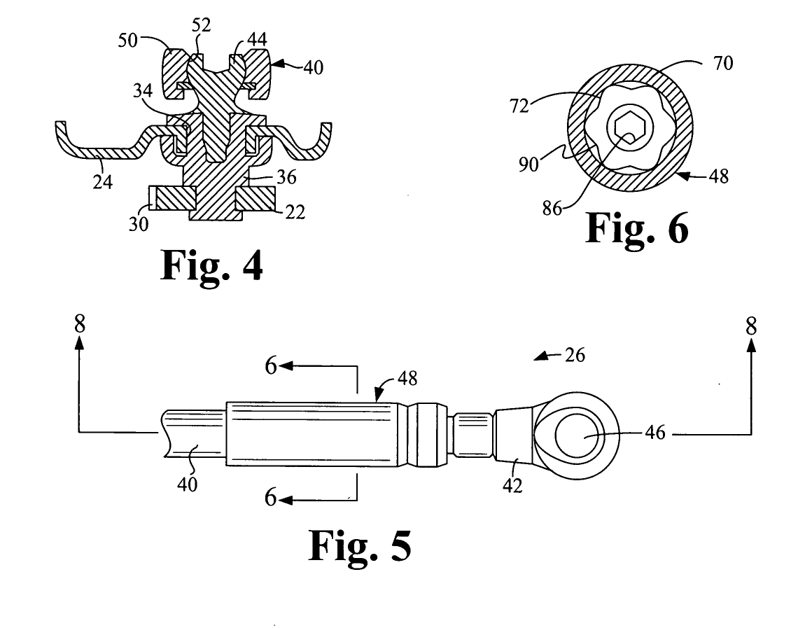

As shown in FIGS. 3 and 4, the guide member 24 includes an elongated slot 34 that retains a sliding member 36. The sliding member 36 is supported in the elongated slot 34 for sliding movement along the length of the elongated slot 34. The sliding member 36 is connected to the rack member 22 in a conventional manner, as shown in FIG. 4. For example, the sliding member 36 can include a fastener (not shown) that extends through the elongated slot 34 and attaches the sliding member 36 to the rack member 22, or can include a rivet or crimped portion (not shown).

With specific reference to FIGS. 3-9, a description of the door rod 26 is now provided. The door rod 26 basically includes a first rod end portion 40, a second rod end portion 42, a pair of swivel joints 44 and 46, and the anti-rattle assembly 18.

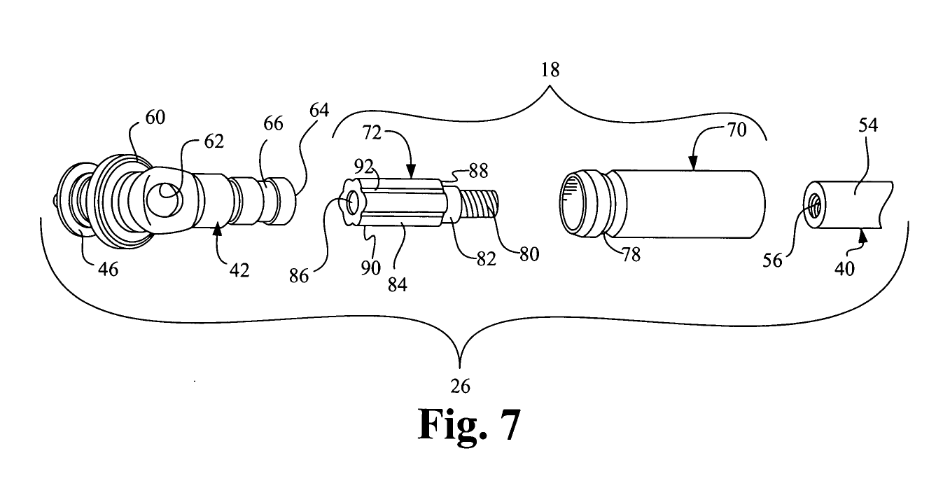

As shown in FIGS. 3 and 4, the first rod end portion 40 is an elongated member that includes a first end 50 with a swivel receiving opening 52 (shown in FIG. 4) that retains the swivel joint 44. As shown in FIG. 7, the first rod end portion 40 also has a second end 54 that includes a threaded aperture 56. The swivel joint 44 is connected to the sliding member 36 (shown in FIG. 4).

As shown in FIG. 7, the second rod end portion 42 also includes a first end 60 that has a swivel receiving opening 62 that retains the swivel joint 46, a second end 64 and an annular recess 66 formed adjacent to the second end 64.

As shown in FIG. 4, the swivel joint 44 operably couples the first rod end portion 40 to the rack member 22 since the rack member 22 is connected to the sliding member 36 and the swivel joint 44 is connected to the first rod end portion 40. The swivel joint 44 allows wide angular displacement of the door rod 26 when the rear door 14 is opened and closed.

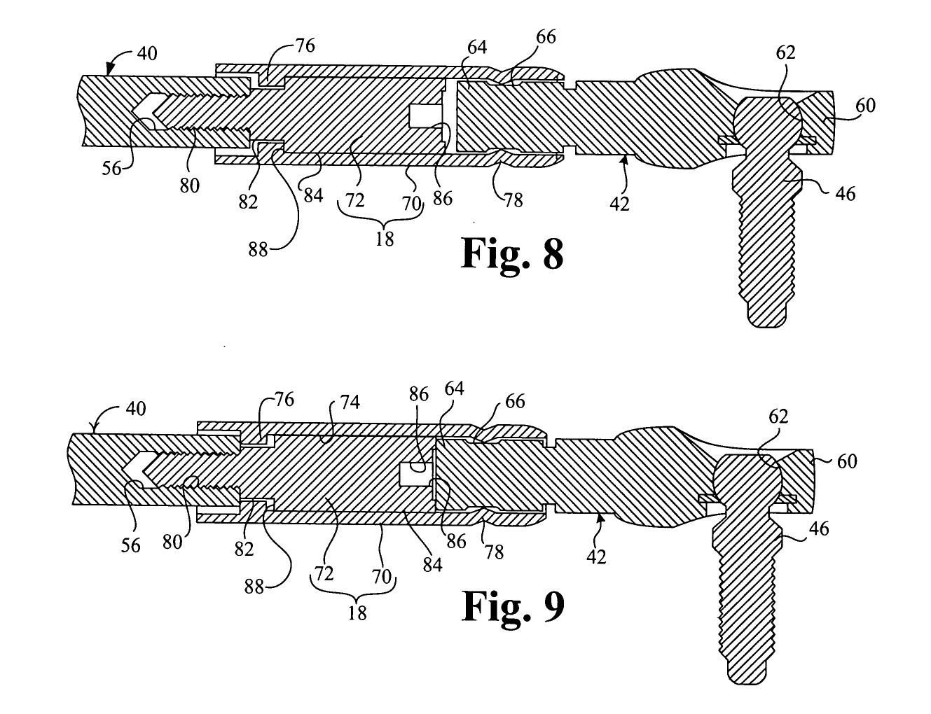

As indicated in FIGS. 8 and 9, the swivel joint 46 has a first end that is retained in the is swivel receiving opening 62 of the first end 60 of the second rod end portion 42 of the door rod 26. As indicated in FIG. 2, the swivel joint 46 has a second end that is connected to the rear door 14 in a conventional manner. Consequently, the second rod end portion 42 is operatively connected to the rear door 14.

As best shown in FIG. 7, the anti-rattle assembly 18 is a connector that basically includes a first member 70 and a second member 72. As described in greater detail below, the first and second members 70 and 72 provide the door rod 26 with a limited telescoping arrangement between the first and second rod end portions 40 and 42. More specifically, the anti-rattle assembly 18 couples the first and second rod end portions 40 and 42 together to provide a limited amount of relative axial movement within the door rod 26 between the first and second rod end portions 40 and 42.

The anti-rattle assembly 18 prevents vibrations of the rear door 14 from being transmitted through the door rod 26 to the motor 19. Specifically, the limited telescoping arrangement of the anti-rattle assembly 18 allows for vibrations to enter the anti-rattle assembly 18, but does not transmit those vibrations to the rack member 22 or to the output gear 20 of the motor 19. However, the limited amount of relative axial movement between the first and second rod end portions 40 and 42 does not interfere with transmission of opening and closing movement of the rear door 14 from the motor 19.

As shown more clearly in FIGS. 8 and 9, the first member 70 basically includes a hollow interior that has an inner surface 74 that has a cylindrical contour and includes an inwardly projecting protrusion 76 that preferably has an annular shape. A portion of the first member 70 is crimped or mechanically deformed to form a crimped portion 78 that protrudes or extends radially inwardly into the annular recess 66 of the second rod end portion 62 trapping the second end 64 of the second rod end portion 42 within the first member of the anti-rattle assembly 18. Preferably, the crimped portion 78 has an inner diameter that is smaller than an outer diameter of the second rod end portion 62 and the same as the diameter of the annular recess 66 of the second rod end portion 62. The first member 70 is fixedly attached to the second rod end portion 42 by the relationship between the crimped portion 78 and the annular recess 66.

As best shown in FIGS. 7, 8 and 9, the second member 72 includes a fastening end 80, shaft portion 82, a movement restricting portion 84 and a tool receiving end 86.

The fastening end 80 includes fastening means such as machine threads engaged with the threaded aperture 56 at the second end 54 of the first rod end portion 40. The shaft portion 82 is a cylindrically shaped area having an outer diameter that is smaller than the outer diameter of the movement restricting portion 84 and also slightly smaller than the inner diameter of the inwardly projecting protrusion 76 of the first member 70.

The movement restricting portion 84 has an outer diameter that is larger than the outer diameter of the shaft portion 82 and larger than the inner diameter of the inwardly projecting protrusion 76 of the first member 70. The movement restricting portion 84 has a stop surface 88 and an outer surface 90 that includes a plurality of longitudinally extending ribs 92. The outer surface 90 further includes a friction reducing coating. The friction reducing coating can be any of a variety of friction reducing materials such as polyoxymethylene (acetal).

The movement restricting portion 84 is at least partially disposed within the hollow interior of the first member 70 of the anti-rattle assembly 18. In the depicted embodiment, the entire movement restricting portion 84 is disposed within the hollow interior of the first member 70 of the anti-rattle assembly 18. The stop surface 88 is dimensioned to contact the inwardly projecting protrusion 76 thereby limiting axial movement between the first and second members 70 and 72 and consequently limiting axial movement between the first and second rod end portions 40 and 42.

The outer most portions of the longitudinally extending ribs 92 on the outer surface 90 contact and are slidable with respect to the inner surface 74 of the first member 70 of the anti-rattle assembly 18. The longitudinally extending ribs 92 are shaped to reduce the overall surface to surface contact between the outer surface 90 and the inner surface 74 of the first member 70. Further, the friction reducing coating on the outer surface 90 reduces friction during axial movement between the first and second members 70 and 72.

The tool receiving end 86 preferably includes an opening configured to receive a wrench, such as a hexagonally shaped wrench (not shown) for tightening the fastening end 80 in the threaded aperture 56 of the first rod end portion 40 of the door rod 26. However, it should be understood from the drawings and the description herein that any of a variety of tool receiving configuration can be provided on or in the tool receiving end 86 of the second member 72.

The second member 72 is in effect an anti-rattle bolt threaded into the first rod end portion 40. Specifically, vibrations of the rear door 14 are transmitted to the door rod 26 but are not necessarily transmitted to the reversible electric motor 19. Since the first and second members 70 and 72 can undergo limited axial movement with respect to one another, transmission of those vibrations to the reversible electric motor 19 are minimized or eliminated.

Although the first and second members 70 and 72 of the anti-rattle assembly 18 can undergo limited relative axial movement with respect to one another, the reversible electric motor 19 can operate effectively to open and close the rear door 14. Specifically, as shown in FIG. 8, the door rod 26 can effectively move as a single unit when under tension. For example, when the rear door 14 is pulled toward a closed position, the door rod 26 is under tension. In this circumstance, the rotation of the output gear 20 of the reversible electric motor 19 moves the rack member 22 causing the door rod 26 to move under tension. The first rod end portion 40 and the first member 72 move relative to the second member 72 of the anti-rattle assembly 18 until the anti-rattle assembly 18 is in the tension orientation depicted in FIG. 8. Specifically, the movement restricting portion 84 of the second member 72 (an anti-rattle bolt) has an axial end face adjacent to the tool receiving end 86 (a tool engaging structure) that is pulled slightly away from the second end 64 of the second rod end portion 42 of the door rod 26. However, the stop surface 88 of the second member 72 of the anti-rattle assembly 18 contacts the inwardly projecting protrusion 76 of the first member 70 of the anti-rattle assembly 18. The second rod end portion 42 is then pulled causing the rear door 14 to move toward the desired position.

Similarly, as shown in FIG. 9, the door rod 26 can effectively move as a single unit when under compression. When the rear door 14 is pushed, the door rod 26 is under compression. The movement restricting portion 84 of the second member 72 (the anti-rattle bolt) has an axial end face adjacent to the tool receiving end 86 (the tool engaging structure) that is pressed against the second end 64 of the second rod end portion 42 of the door rod 26. In this circumstance, the rotation of the output gear 20 of the reversible electric motor 19 moves the rack member 22 causing the door rod 26 to move under compression. The first rod end portion 40 and the first member 72 move relative to the second member 72 of the anti-rattle assembly 18 until the anti-rattle assembly 18 is in the compression orientation depicted in FIG. 9. The second rod end portion 42 is then pushed causing the rear door 14 to move toward the desired position.

It should be understood from the drawings and description herein, that the general location of the anti-rattle assembly 18 is variable. Specifically, the anti-rattle assembly 18 can be located as shown proximate the second end 64 of the second rod end portion 42 or can be located any where along the length of the door rod 26, depending upon space constraints and other design criteria. Further, the features described above with respect to the first and second rod end portions 40 and 42 are interchangeable. Specifically, the first rod end portion 40 can be fixedly coupled to the rear door 14 via the one of the swivel joints 44 or 46, and the second rod end potion 42 can be coupled to the sliding member 36 and the rack member 22 via the other of the swivel joints 44 or 46.

The frame portions of the vehicle 10, including the cargo area 12, the interior wall W and the rear door 14 are conventional components that are well known in the art. Since these components are well known in the art, these structures will not be discussed or illustrated in detail herein. Rather, it will be apparent to those skilled in the art from this disclosure that the components can be any type of structure and/or programming that can be used to carry out the present invention.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward, rearward, above, downward, vertical, horizontal, below and transverse” as well as any other similar directional terms refer to those directions of a vehicle equipped with the present invention. Accordingly, these terms, as utilized to describe the present invention should be interpreted relative to a vehicle equipped with the present invention.

The terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A vehicle door operating mechanism comprising:
a reversible electric motor having an output gear;
a rack member having teeth engaged with the output gear and movably arranged relative to the motor so that the rack member moves in response to rotation of the output gear of the motor; and
a door rod having a first rod end portion operatively coupled to the rack member, a second rod end portion configured and arranged to be operatively connected to a vehicle door, and a connector coupling the first and second rod end portions together to provide a limited amount of relative axial movement within the door rod between the first and second rod end portions.

2. The vehicle door operating mechanism as set forth in claim 1, wherein
the connector includes a telescoping arrangement between the first and second rod end portions.

3. The vehicle door operating mechanism as set forth in claim 2, wherein
the telescoping arrangement includes a first member fixedly attached to one of the first and second rod end portions and a second member fixedly attached to the other of the first and second rod end portions.

4. The vehicle door operating mechanism as set forth in claim 3, wherein
the first member is crimped to the one of the first and second rod end portions.

5. The vehicle door operating mechanism as set forth in claim 3, wherein
the second member is an anti-rattle bolt threaded into the other of the first and second rod end portions.

6. The vehicle door operating mechanism as set forth in claim 5, wherein
the first member is crimped to the one of the first and second rod end portions.

7. The vehicle door operating mechanism as set forth in claim 3, wherein
the first member includes an inner surface with an inwardly projecting protrusion that limits movement of the second member with respect the first member.

8. The vehicle door operating mechanism as set forth in claim 7, wherein
the second member includes a rod connecting portion connected to the other of the first and second rod end portions and a movement restricting portion that selectively contacts the protrusion of the first member and the one of the first and second rod end portions that is connected to the first member.

9. The vehicle door operating mechanism as set forth in claim 8, wherein
the second member is an anti-rattle bolt with the rod connecting portion having threads threaded into the other of the first and second rod end portions.

10. The vehicle door operating mechanism as set forth in claim 9, wherein
the movement restricting portion of the anti-rattle bolt has an axial end face with a tool engaging structure.

11. The vehicle door operating mechanism as set forth in claim 3, wherein
the first member includes a hollow interior and the second member includes a movement restricting portion that at least partially disposed within the hollow interior.

12. The vehicle door operating mechanism as set forth in claim 11, wherein
the movement restricting portion of the second member has an outer surface with a plurality of longitudinally extending ribs.

13. The vehicle door operating mechanism as set forth in claim 11, wherein
the movement restricting portion of the second member has an outer surface with a friction reducing coating.

14. The vehicle door operating mechanism as set forth in claim 13, wherein
the friction reducing coating includes polyoxymethylene (acetal).

15. The vehicle door operating mechanism as set forth in claim 1, wherein
the second rod end portion includes a swivel joint having a first end coupled to the second rod end portion and a second end configured for connection to the vehicle door.

16. The vehicle door operating mechanism as set forth in claim 1, further comprising:
a guide member having an elongated slot with a sliding member of the first rod end portion of the door rod being supported in the elongated slot for sliding movement along the elongated slot.

17. The vehicle door operating mechanism as set forth in claim 16, wherein
the sliding member includes a swivel joint operably connecting the first rod end portion of the door rod to the sliding member.
